(19) United States
(12) Patent Application Publication
(10) Pub. No.: US 2003/0120408 A1
(43) Pub. Date: Jun. 26, 2003

(54) Vehicle occupant restraint deployment safing system

(76) Inventors: Christopher Michael Caruso, Kokomo, IN (US); Charles A. Cluff, Zionsville, IN (US); Russell L. Simpson, Noblesville, IN (US); David L. Nelson, Kokomo, IN (US); Christopher Brian Lagrave, El Paso, TX (US); Mary Jane Olsavsky, Cicero, IN (US)

Correspondence Address: ROBERT M. SIGLER, DELPHI TECHNOLOGIES, INC., Legal Staff, Mail Code: 480-414-420, P.O. Box 5052, Troy, MI, 48007-5052, US

(21) Appl. No.: 10/029,213

(22) Filed: Dec. 20, 2001

(51) Int. Cl. B60R 21/32

(52) U.S. Cl. 701/45; 280/735; 180/282

(57) ABSTRACT

An occupant restraint deployment apparatus for a vehicle has a passenger compartment crash sensor and a plurality of satellite crash sensors, typically in vehicle crush zones. The satellite sensors are each responsive to local acceleration to generate a satellite deploy level signal having discrete values. The passenger compartment sensor is responsive to a passenger compartment (i.e. vehicle) acceleration to generate a passenger compartment deploy level signal and a passenger compartment safing signal. A multi-stage restraint in the passenger compartment is deployable by a control acting in three parallel modes, each requiring a deploy signal from one of the crash sensors based on full deploy requirements and a safing signal, typically based on lesser requirements, from a different one of the crash sensors. The three modes differ in which sensors provide each of the signals: (1) satellite deploy, passenger safe; (2) satellite deploy, different satellite safe; and (3) passenger deploy, satellite safe. Each satellite deploy level signal can be used either as a deploy signal or a safing signal, with predetermined values signifying deploy or safe at each deployment stage.

### TECHNICAL FIELD

The technical field of this invention is occupant restraint deployment systems for motor vehicles.

### BACKGROUND OF THE INVENTION

Regulations and market expectations are requiring ever greater degrees of sophistication and complexity in vehicle occupant restraint deployment systems. The vehicle passenger compartment crash sensor may now be supplemented by satellite sensors in frontal and/or side crush zones. The systems are discriminating different levels of restraint deployment on the basis of sensors that detect the presence of vehicle occupants and classify them by weight and/or position. Reliability of the deploy/no deploy decision is being improved with more sophisticated deployment decision algorithms and with arming and/or safing sensors. These developments are leading to increased complexity and cost in the systems, particularly with respect to deployment and safing decisions.

### SUMMARY OF THE INVENTION

The invention provides a multi-stage occupant restraint deployment apparatus for a vehicle having a unique control structure to minimize cost and complexity while coordinating multiple crash sensors and requiring deploy and safing determinations derived from different sensors to prevent single point system failures. An occupant restraint deployment apparatus according to the invention includes a first crash sensor at a first location outside a passenger compartment responsive to a first location acceleration to derive a first satellite deploy level signal and a second crash sensor at a second location outside the passenger compartment responsive to a second location acceleration to derive a second satellite deploy level signal. It further includes a crash discriminator programmed to deploy the occupant restraint in a first deployment stage in response to receipt of (1) the first satellite deploy level signal having a value at least equal to a first predetermined deploy value corresponding to the deployment stage and (2) the second satellite deploy level signal having a value at least equal to a first predetermined safing value corresponding to the first deployment stage.

In a preferred embodiment, the first predetermined deploy value corresponding to the first deployment stage has a greater magnitude than the first predetermined safing value corresponding to the first deployment stage. In addition, the crash discriminator may be further programmed to deploy the occupant restraint in a second, higher deployment stage in response to receipt, within a predetermined time period, of (1) the first satellite deploy level signal having a value at least equal to a second predetermined deploy value corresponding to the second deployment stage and (2) the second satellite deploy level signal having a value at least equal to a second predetermined safing value corresponding to the second deployment stage, wherein the second predetermined deploy value corresponding to the second deployment stage has a smaller magnitude than the second predetermined safing value corresponding to the second deployment stage.

Furthermore, in another preferred embodiment, apparatus further includes a third crash sensor in the passenger compartment responsive to a passenger compartment acceleration to derive a first passenger compartment deploy level signal. The crash discriminator is further programmed to deploy the occupant restraint in the first deployment stage in response to receipt, within a predetermined time period, of (1) the first passenger compartment deploy level signal having a value at least equal to a third predetermined deploy value corresponding to the first deployment stage and (2) the first satellite deploy level signal having a value at least equal to a third predetermined safing value corresponding to the first deployment stage.

### BRIEF DESCRIPTION OF THE DRAWINGS

FIG. 1 is a schematic diagram of an occupant restraint deployment apparatus according to the invention.

FIG. 2 is a schematic diagram of the control and sensor hardware arrangement in the apparatus of FIG. 1.

FIG. 3 is a flow chart partially illustrating the operation of the apparatus of FIG. 1.

FIGS. 4A, 4B, 4C are logic diagrams illustrating three modes of operation for the apparatus of FIG. 1.

FIG. 5 is a charted boundary curve expressing the magnitude of a dynamic parameter as a function of Event Duration for a potential crash event.

FIGS. 6A, 6B show a flow chart further illustrating the operation of the apparatus of FIG. 1.

### DESCRIPTION OF THE PREFERRED EMBODIMENT

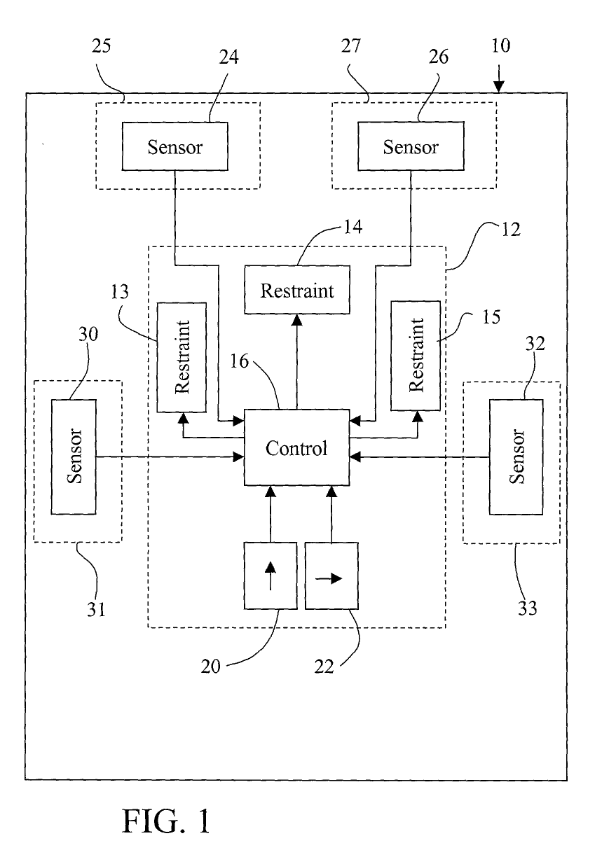

FIG. 1 shows a schematic diagram of a vehicle 10 having a passenger compartment 12. Occupant restraints are provided in the passenger compartment: in this embodiment a front restraint 14 and side restraints 13 and 15. But other restraint arrangements are known and would be appropriate. Deployment of restraints 13, 14 and 15, as well as any others, is controlled by a control 16, also known as the SDM. In this embodiment, restraints 13, 14 and 15 are multi-stage restraints, which may be deployed in several stages, depending on sensed crash severity and/or occupant situations. For example, a first stage might deploy a belt pre-tensioner for protection in a low level crash; a second stage could provide a first restraint inflation and a third stage could provide a second restraint inflation. The differences in the first and second restraint inflation could involve different numbers of inflators or bags; and the number of such stages could be expanded if desired. This invention is particularly well suited for restraint systems including inflatable restraints having two inflators to provide two stages of inflation if the second stage is initiated simultaneously or within a small time duration after the first stage, so that the restraint is inflated to a higher pressure than is achieved by the first stage alone.

Vehicle 10 is equipped with a plurality of crash sensors, each preferably accelerometer based in this embodiment. A longitudinal accelerometer 20 and a lateral accelerometer 22 in passenger compartment 12 each provide an acceleration signal to a microcomputer 17 within SDM 16, with which they are typically packaged in a single module known as the SDM. Microcomputer 17 is programmed to process the longitudinal and lateral acceleration signals and use them in generating an SDM sensor based deploy level signal based on comparison of one or more vehicle dynamic parameter derived from the longitudinal and lateral acceleration signals with one or more boundary curves expressing threshold levels as a function of event duration. A general example of a boundary curve is shown in FIG. 5, wherein a boundary curve threshold, represented by dashed line 80, represents the magnitude of a dynamic parameter, such as velocity or acceleration, as a function of event duration from the initiation of a potential crash event. Sample curves of sensed or derived values of the dynamic parameter show, in line 82, an event in which the parameter does not exceed the boundary curve 80 and, in line 84, an event in which the parameter does exceed the boundary curve.

Vehicle 10 is additionally equipped with a plurality of satellite sensors located outside passenger compartment 12, generally (but not necessarily) in a vehicle crush zone defined near the outer surface of the vehicle. Each of these satellite sensors preferably includes an accelerometer and a small microcomputer for processing the accelerometer signal and generating a satellite sensor based deploy level signal from the processed accelerometer signal during a crash event, which signals are all provided to control 16 on dedicated lines or on a bus. Two of these satellite crash sensors are located at the front of the vehicle: sensor 24 at the left front in crush zone 25 and sensor 26 at the right front in crush zone 27. These sensors are primarily intended to sense frontal crashes requiring the deployment of restraint 14; but either may provide a signal useful in side or angle crashes for determining deployment of a side restraint such as restraint 13 or restraint 15. Two more of these satellite crash sensors are located near the sides of the vehicle: sensor 32 in crush zone 33 on the left side and sensor 34 in crush zone 35 on the right side. These sensors are primarily intended to sense side crashes requiring the deployment of a side restraint such as restraint 13 or restraint 15; but either may provide a signal useful in front or angle crashes for determining deployment of a frontal restraint such as restraint 14. Each of the satellite sensors 24, 26, 32 and 34 is responsive to accelerations in its own crush zone and is likely to provide early information on crash severity if the vehicle is struck in the location of that crush zone, since significant energy will be absorbed in the crushing body structure near the point of impact before significant energy absorption and accelerations occur in the main body structure of the passenger compartment. But such satellite sensors, sensitive mostly to accelerations in their own crush zones, are also more prone to acceleration producing events other than crashes.

The process performed by each satellite sensor is described with reference to FIG. 3. The satellite sensor is programmed to sense the presence of a potential crash event in step 40. The initial detection of such an event may be indicated, for example, when a dynamic function of a sensed accelerometer output exceeds a predetermined reference threshold. The threshold would be low compared with any boundary level curve used in actually signaling a deploy level. When the initiation of such an event was first detected, an Event flag would be set. Continuation of such an event would be detected by checking the Event flag. Once the initiation of a potential crash event is sensed and the Event flag is set, an event timer is triggered to keep track of an event duration. The event duration controls the application of any boundary curves for determining if a deploy level signal is generated and also determines the end of the crash event, as known in the art. During the event, the dynamic function datum is repeatedly compared at step 42 with one or more boundary curves that are functions of event duration to determine if a new Deploy Level has occurred. If a new Deploy Level has occurred, the new Deploy Level is communicated to microcomputer 17 in the SDM. For example, if the dynamic function datum exceeds the boundary curve for level 1, a Level 1 Deploy signal is provided to the SDM. Subsequently, if the dynamic function datum exceeds the boundary curve for level 3, a Level 3 Deploy signal is provided to the SDM. If the dynamic function datum should fall below the level of a boundary curve already crossed and signaled, the signal will cease; thus any signal will exist only while its associated boundary curve is exceeded. Once a predetermined time elapses after the initiation of an event, the Event flag is reset until a new potential crash event initiation is detected.

The deploy level signals from the satellite sensors may comprise any number of levels as determined by the system designer; and the boundary curve values, which are stored in the memory of the satellite sensor computer, are determined by calibration for a particular vehicle. They are nominally associated with particular deploy stages; although how they are used by the signal receiving microcomputer 17 in the SDM are determined by the SDM programming, which will be discussed at a later point in this description.

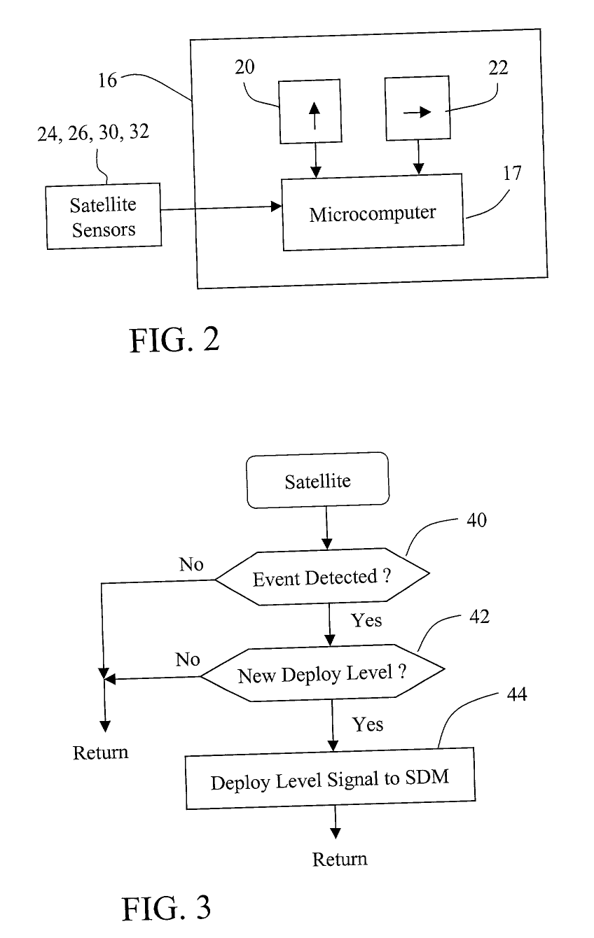

Microcomputer 17 is programmed to receive the deploy level signals from the satellite crash sensors 24, 26, 30 and 32, as seen in FIG. 2. Microcomputer 17 is programmed to control the deployment of restraint 14 in response to these deploy level signals and its own processing of signals from SDM accelerometers 20 and 22. These SDM signals comprise two basic types: (1) SDM deploy level signals and (2) auxiliary boundary level (ABC) signals. The former may be based on a velocity datum derived from the longitudinal acceleration signal from one of sensors 20 and 22; the latter may be based on such a velocity parameter and an additional criterion such as, for example, a predetermined magnitude of a filtered acceleration parameter. In this embodiment, only the SDM generates the auxiliary boundary level signals.

The program within microcomputer 17 requires two signals to initiate restraint deployment in a given deployment stage: (1) a deploy level signal from a first sensor, and (2) safing signal for the same deploy level from a second, different sensor. The difference between a deploy signal and a safing signal is that a deploy signal requires the full requirements necessary to indicate a given deploy stage, but a safing signal for the given deploy stage is provided at a lower requirement level but by a different sensor than that which provides the deploy signal for the deploy stage. The safing signal from a different sensor provides a backup level of confidence for the deploy indicating sensor to reduce the possibility of a single point failure. In addition, it should be noted that, in this description, a “stage” of restraint deployment refers to the physical characteristics of restraint deployment (what restraint device and how), but a deploy “level” refers to a signal produced by a crash sensor. The relation between a deploy level signal and a restraint stage resulting therefrom depends on the programming of microcomputer 17 in the SDM.

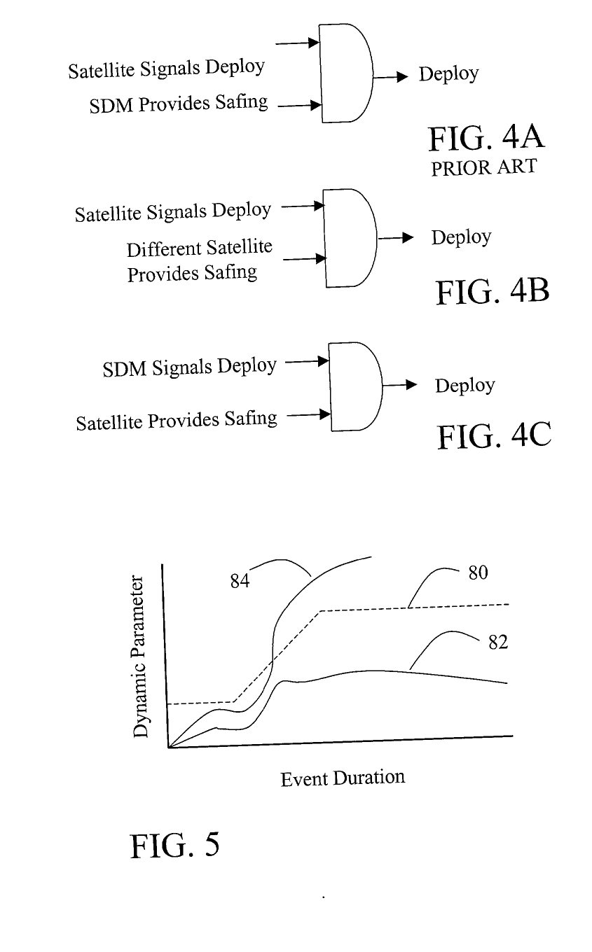

The operation of the program in SDM microcomputer 17 encompasses three modes of determining when a restraint should be deployed. These three modes essentially operate simultaneously; and any one of them may initiate a restraint deployment. Each of these three modes requires a deploy signal from one sensor and a safing signal from a different sensor: the modes are distinguished by which sensors are used in each capacity. The first mode, shown in logical form in FIG. 4A, is known in the prior art. In this mode, the deploy signal originates in a satellite sensor and the safing signal is produced in the SDM. In the second mode, which is new and shown in logical form in FIG. 4B, the deploy signal originates in one satellite sensor and the safing signal originates in a different satellite sensor. In the third mode, which is also new and is shown in logical form in FIG. 4C, the deploy signal originates in the SDM and a safing signal is produced by a satellite sensor. The third mode of operation has limited useful application but is useful in certain crash events that are difficult for the other modes.

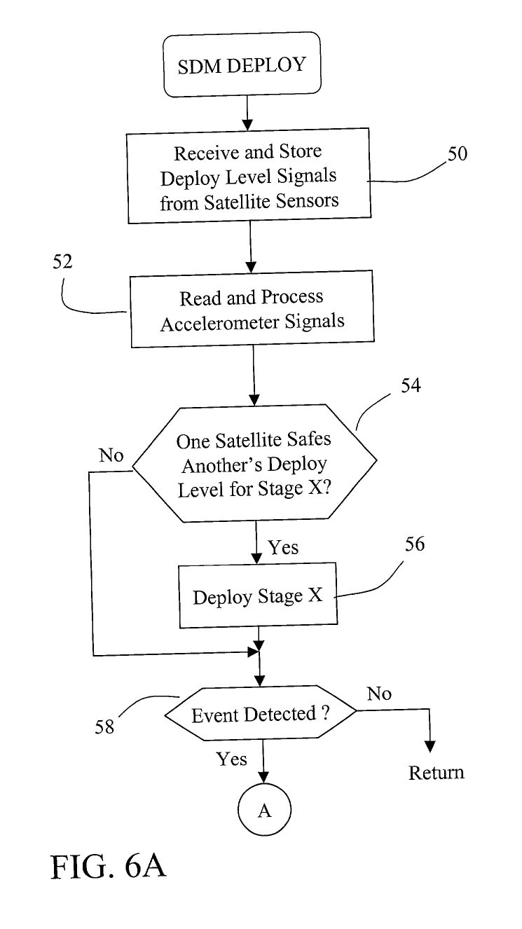

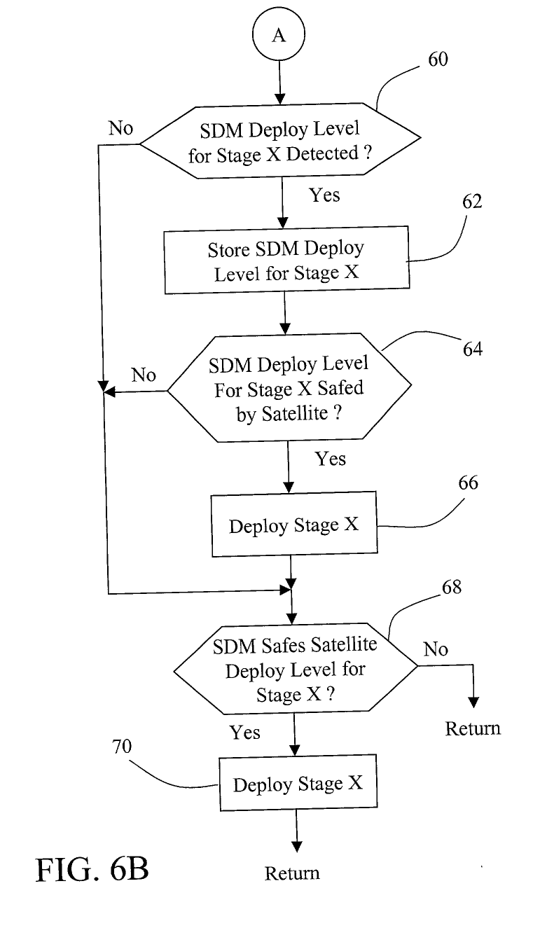

Operation of the program in SDM microcomputer 17 is described with reference to the flow charts of FIGS. 6A and 6B. The program SDM Deploy begins at step 50, shown in FIG. 6A, where it receives and stores any deploy level signals output by the satellite sensors. Each deploy level signal received represents input from a satellite sensor that a restraint deployment of the indicated stage is requested. The storage is performed in the loop in which the signal is received; and the stored signal is latched for a predetermined period such as, for example, 50 milliseconds. At step 52 the program reads the outputs of accelerometers 20 and 22 and performs initial processing to derive any other required parameters.

At step 54 the program determines, from the stored deploy level signals from the satellite sensors, if deploy level and safing signals for a stage X deployment are simultaneously stored, where X is the variable denominator for any particular one of the possible deployment stages. For example, in a Stage 2 deployment (X=2), the minimum deploy level signal for a particular satellite sensor may be defined as Deploy Level 3 and a safing signal for the same stage from another satellite sensor may be Deploy Level 1. If these signals have been received from those sensors and are still retained in memory, a Stage 2 deployment is required and authorized. Thus, if the required deploy level signals for deployment and safing are present in memory for stage X from two different satellite sensors, the restraint is deployed at the level of Stage 2 at step 56. In this embodiment, a Stage X deployment includes all stages up to and including X; so in this example, both stages 1 and 2 will be deployed. This is a mode 2 deployment as described earlier and shown in FIG. 4B.

The mode 2 deployment described in the previous paragraph is the only mode in which the SDM does not require its own generated deploy level or safing signal. Such signals can only be generated when the SDM itself detects a potential crash event, since the application of boundary curve references are timed from the initiation of a sensed crash even. Thus, the program determines at the next step 58 if a potential crash event is detected by the SDM. This is done in essentially the same manner as that described above for the satellite sensors: a dynamic function of the output of one of accelerometers 20 and 22 (typically the acceleration itself) exceeds a predetermined reference threshold that is low compared with any boundary level curve used in actually signaling a deploy level. When the initiation of such an event is first detected, an Event flag would be set and an event timer (counter) is initiated. Continuation of such an event is detected by checking the Event flag; and the event timer is updated on a regular basis. The Event flag will remain set for a predetermined time sufficient to allow detection of a crash and useful deployment of the restraint and then will be automatically reset.

If no event is detected at step 58, the program returns for the next loop; but if a potential crash event is detected at step 58, either initially or by a set Event flag, the program proceeds to step 60, shown in FIG. 6B. This step is the first of several dealing specifically with mode 3 operation as discussed above and shown in FIG. 4C. SDM accelerometers 20 and 22 see accelerations of the total vehicle, which are generally smaller and/or later than those seen by the satellite sensors. But there may exist certain potential crash events that do not produce a large acceleration of a satellite sensor; and the third mode is included to deal with these potential crash events. For example, if the vehicle hits an obstacle that does not produce crushing in a front or side crush area, the crash sensors 24, 26, 30 or 32 may not see an acceleration resulting in a deploy signal level sufficiently high to signify a second stage deployment. An example of such an event is a vehicle stopped dead by a high curb engaged by the vehicle undercarriage near the floor pan, with no crushing in a crush zone having a satellite sensor. The SDM accelerometers 20 and 22 are good at sensing the severity of such events, which involve deceleration of the entire vehicle; but they can be fooled by an event in which the vehicle strikes a lower curb. The latter event may not produce a vehicle deceleration requiring deployment but may produce vibrational accelerations sufficient to cause a high deploy level signal. A satellite sensor may sense the acceleration produced by the vehicle stopping curb-strike event sufficiently to generate a low deploy level signal without producing such a signal in the glancing blow curb-strike event. It thus can be used to safe the SDM deploy level signal for the vehicle stopping curb-strike event, wherein restraint deployment is required.

At step 60, the program determines if a deploy level signal should be generated by the SDM. This is determined by any known method, for example by comparing a dynamic parameter such as the longitudinal or lateral velocity of the vehicle derived from the output of accelerometer 20 or 22, respectively (depending on whether the restraint is placed for a frontal or a side crash) with a threshold boundary curve for each of the deploy levels. If the dynamic parameter exceeds the boundary curve for a given Deploy Level, a Deploy Level signal will be generated and stored at step 62. From step 62, the program proceeds to check at step 64 for a stored safing signal from a satellite sensor corresponding to Stage X authorized by the Deploy Level signal stored at step 62. If such a safing signal is found, restraint 14 is deployed in a Stage X deployment. Of course, if the restraint has already been deployed with stage X or a lower stage, it cannot be re-deployed. On the other hand, if the restraint has already been deployed at a lower stage, it will now be deployed with any additional stages up to and including stage X.

From step 60 if no deploy level is detected, from step 62 if the stored Deploy Level signal is not safed, or from step 66, the program proceeds to step 68, wherein it determines whether to generate a safing signal(s) for any stored, satellite sensor generated Deploy Level signals. Unlike the satellite sensors, which are equipped with smaller microprocessors having less speed and/or memory capacity, the SDM provides specialized safing signals separate from its own Deploy Level signals and determined in a different process. This process may, for example, require each of a velocity parameter and a filtered acceleration parameter to exceed respective boundary curves. If a safing requirement is met for a given stage X corresponding to that authorized by a stored satellite Deploy Level signal, the program proceeds to initiate a stage X deployment of restraint 14. As with previously described deployments, this deployment is not initiated if the restraint has already been deployed with stage X or lower; and the deployment that is initiated will include all undeployed stages up to and including X. If the safing requirement is not met, the program returns for the next loop.

A significant advantage of the invention described herein is its improved flexibility in dealing with multi-stage restraints of the type having multiple inflators. Such restraints may be deployed with a first inflator only to a first pressure or with a first and second inflator together to a second, greater pressure. But in order to achieve the second, greater pressure, the second stage inflator must be deployed so that the inflating gas pressures of both inflators are effectively added. This means that the second stage inflator must be deployed very soon after the first stage inflator, and preferably simultaneously therewith. If the second stage inflator cannot be activated in time, there is no effective second stage deployment.

In most crash events, there is more time available for a first stage deployment than a second stage deployment, since the restraint pressure is lower in the former. On the other hand, it generally takes longer to detect the need for a second stage deployment than it does to detect a first stage deployment. These two facts, together with the nature of the multi-stage restraint as described in the previous paragraph, present a dilemma for the restraint system designer, since they present somewhat contradictory requirements. But the apparatus and method described herein permits the designer of a restraint deployment for a particular vehicle to calibrate the deploy levels of the sensors to help reconcile these requirements. The designer is able to delay a first stage deployment by requiring a higher deploy level signal from the sensors used for safing the first stage deployment. But the designer requires a lower deploy level signal from the same sensors used for safing the second stage deployment. Thus, when a deploy level signal sufficient for first stage deployment is generated by one sensor without a matching deploy level signal from another sensor sufficient to safe the first stage deployment, the first sensor's deploy level signal is just stored for a predetermined time. If, within that predetermined time, a deploy level signal is received from one sensor that is sufficient for a second stage deployment and a deploy level signal is received from another sensor that is sufficient to safe a second stage deployment, then the first and second inflators can be deployed simultaneously as designed. The likelihood of this occurring is increased by setting the deploy level for safing a first stage deployment at a high value to take advantage of the extra time available for first stage deployment and setting the deploy level for a second stage deployment low (lower than the deploy level for safing a first stage deployment) to obtain immediate safing of a deploy level signal indicating second stage deployment.

1. An occupant restraint deployment apparatus for a vehicle having a passenger compartment and first and second locations outside the passenger compartment comprising:
an occupant restraint in the passenger compartment capable of deployment in first and second deployment stages;
a first crash sensor at the first location outside the passenger compartment responsive to a first location acceleration to derive a first satellite deploy level signal;
a second crash sensor at the second location outside the passenger compartment responsive to a second location acceleration to derive a second satellite deploy level signal; and
a crash discriminator programmed to deploy the occupant restraint in a first deployment stage in response to receipt, within a predetermined time period, of (1) the first satellite deploy level signal having a value at least equal to a first predetermined deploy value corresponding to the first deployment stage and (2) the second satellite deploy level signal having a value at least equal to a first predetermined safing value corresponding to the first deployment stage.

2. The occupant restraint deployment apparatus of claim 1 wherein the first predetermined deploy value corresponding to the first deployment stage has a greater magnitude than the first predetermined safing value corresponding to the first deployment stage.

3. The occupant restraint deployment apparatus of claim 2 wherein the crash discriminator is further programmed to deploy the occupant restraint in a second deployment stage higher than the first deployment stage in response to receipt, within a predetermined time period, of (1) the first satellite deploy level signal having a value at least equal to a second predetermined deploy value corresponding to the second deployment stage and (2) the second satellite deploy level signal having a value at least equal to a second predetermined safing value corresponding to the second deployment stage, wherein the second predetermined deploy value corresponding to the second deployment stage has a smaller magnitude than the second predetermined safing value corresponding to the second deployment stage.

4. The occupant restraint deployment apparatus of claim 1 further comprising a third crash sensor in the passenger compartment responsive to a passenger compartment acceleration to derive a first passenger compartment deploy level signal, wherein the crash discriminator is further programmed to deploy the occupant restraint in the first deployment stage in response to receipt, within a predetermined time period, of (1) the first passenger compartment deploy level signal having a value at least equal to a third predetermined deploy value corresponding to the first deployment stage and (2) the first satellite deploy level signal having a value at least equal to a third predetermined safing value corresponding to the first deployment stage.
